(19) United States
(12) Patent Application Publication
(10) Pub. No.: US 2009/0102821 A1
(43) Pub. Date: Apr. 23, 2009

(54) PORTABLE DIGITAL PHOTOGRAPH ALBUMS AND METHODS FOR PROVIDING THE SAME

(76) Inventors: Steven R. Pargman, Palm Springs, CA (US); Ralph A. Skidmore, Palm Springs, CA (US); Karl Kane, Bangkok (TH)

Correspondence Address: ROPES & GRAY LLP, PATENT DOCKETING 39/361, 1211 AVENUE OF THE AMERICAS, NEW YORK, NY, 10036-8704, US

(21) Appl. No.: 12/256,037

(22) Filed: Oct. 22, 2008

Related U.S. Application Data
(60) Provisional application No. 60/999,956, filed on Oct. 22, 2007.

(51) Int. Cl. G09G 5/00

(52) U.S. Cl. 345/204

(57) ABSTRACT

Portable digital photograph albums are provided. Such albums may include an electronic component for displaying digital photographs and a compartment for receiving the electronic component. The electronic component may include a display device, a processor, a battery, an input device, a storage device, and an I/O interface device. The electronic component may be capable of electrically coupling with an external power source, portable storage media or another electronic device. The electronic component may be interchangeable amongst a plurality of photograph albums. An easel bracket may be provided, and the electronic component may be disposed in a plurality of photograph albums and the easel bracket without the use of tools.

### CROSS REFERENCE TO RELATED APPLICATIONS

This application claims the benefit of copending, commonly-assigned U.S. Provisional Patent Application No. 60/999,956 filed Oct. 22, 2007, which is hereby incorporated by reference herein in its entirety.

### BACKGROUND OF THE INVENTION

Various factors limit the functionality and portability of traditional photograph albums. For example, each photograph stored in a traditional album increases the album's size and weight and makes the album more difficult to carry. Accordingly, a traditional album cannot hold a large number of photographs and still be considered portable. Moreover, a user wanting to give away copies of a photograph (e.g., after viewing the album with a friend) must carry extra copies in the album, adding to its size and weight. The difficulty of changing photographs is another factor limiting the functionality of traditional photograph albums. For example, a user may need to physically remove each old photograph and replace it with a new photograph to update an album.

Additionally, traditional photograph albums do not make displaying photographs convenient. For example, if a user wishes to passively display photographs from a photo album (e.g., like a framed picture), only those photographs placed together on a given page may be displayed at a time. Further, the bulky size of traditional photo albums does not lend them to be displayed for others to passively view (e.g., on a shelf). Instead, when a user has finished actively viewing a traditional photo album, the album is left closed and placed in storage. In addition, traditional photo albums do not come with an apparatus for allowing an album to be displayed (e.g., a stand or easel).

Accordingly, it would be advantageous to be able to provide a portable digital photograph album with improved features over a traditional photo album.

### SUMMARY OF THE INVENTION

Portable digital photograph albums are provided. Such albums may include an electronic component for displaying digital photographs and a compartment for receiving the electronic component. The electronic component may include a display device, a processor, a battery, an input device, a storage device, and an I/O interface device. The electronic component may be capable of electrically coupling with an external power source, portable storage media or another electronic device. The electronic component may be interchangeable amongst a plurality of photograph albums.

In accordance with an embodiment, a digital photograph album device is provided. The album device may include a rear cover and a front cover coupled to the rear cover. The album device may further include a compartment disposed between the front cover and the rear cover and having an aperture. The digital photograph album device may also include an electronic component disposed within the compartment. The electronic component may include a display device visible through the aperture and a processor. The display device may be electrically coupled to the processor and may display one or more digital photographs.

In accordance with an embodiment, a digital photograph album device is provided. The album device may include a rear cover and a front cover coupled to the rear cover. The album device may further include an interchangeable electronic component disposed between the front cover and the rear cover. The interchangeable component may have a processor and a display device. The processor may be electrically coupled to the display device, and the display device may display one or more digital photographs. The interchangeable electronic component may be removed from the device without tools.

In accordance with an embodiment of the present invention, a method for providing a portable photograph album is provided. The method includes providing an electronic component that includes a processor electrically coupled to a display device for displaying one or more digital photographs. The method further includes providing an assortment of photograph albums from which a consumer can select at least one album. Each album in the assortment may include a mounting bracket comprising a first plurality of mounting clips sized to receive the electronic component. The method further includes providing an easel bracket that comprises a second plurality of mounting clips sized to receive the electronic component.

In accordance with an embodiment of the present invention, a digital photograph album device is provided. The album device may include a rear cover and a front cover coupled to the rear cover. The album device may further include a mounting bracket disposed between the front cover and the rear cover. The digital photograph album device may also include an electronic component disposed anterior to the mounting bracket. The electronic device may include a display device and a processor. The display device may be electrically coupled to the processor and may display one or more digital photographs.

### BRIEF DESCRIPTION OF THE DRAWINGS

The above and other features of the present invention, its nature and various advantages will be more apparent upon consideration of the following detailed description, taken in conjunction with the accompanying drawings, in which like reference characters refer to like parts throughout, and in which:

FIG. 1 shows a simplified schematic of a photograph album in accordance with various embodiments of the present invention;

FIG. 2 shows a front perspective view of a photograph album in accordance with an embodiment of the present invention;

FIGS. 3A and 3B are perspective views of a photograph album in accordance with an embodiment of the present invention;

FIG. 4 shows a side perspective view of a photograph album in accordance with an embodiment of the present invention;

FIG. 5 shows a front perspective view of an electronic component provided in a photograph album in accordance with an embodiment of the present invention;

FIG. 6 shows a front perspective view of a photo album for receiving an electronic component in accordance with an embodiment of the present invention;

FIG. 7A shows a front perspective view of an electronic component for use in a photograph album in accordance with an embodiment of the present invention;

FIG. 7B shows a side, elevational view of an electronic component for use in a photograph album in accordance with an embodiment of the present invention;

FIG. 8 shows a front perspective view of an electronic component provided in a photograph album in accordance with an embodiment of the present invention;

FIG. 9 shows an illustrative flowchart for providing a photograph album in accordance with an embodiment of the present invention;

FIG. 10 shows a front perspective view of a photograph album in accordance with an embodiment of the present invention;

FIG. 11A shows a front perspective view of a photograph album in accordance with an embodiment of the present invention;

FIGS. 11B and 11C show perspective views of a mounting clip provided in a photograph album in accordance with an embodiment of the present invention;

FIG. 11D shows a front perspective view of an electronic component provided in a photograph album in accordance with an embodiment of the present invention;

FIG. 12A shows a front perspective view of an electronic component for use in a photograph album in accordance with an embodiment of the present invention;

FIG. 12B shows a rear perspective view of an electronic component for use in a photograph album in accordance with an embodiment of the present invention;

FIG. 13A shows a front perspective view of an easel bracket in accordance with an embodiment of the present invention.

FIG. 13B shows a rear perspective view of an easel bracket in accordance with an embodiment of the present invention.

### DETAILED DESCRIPTION OF THE INVENTION

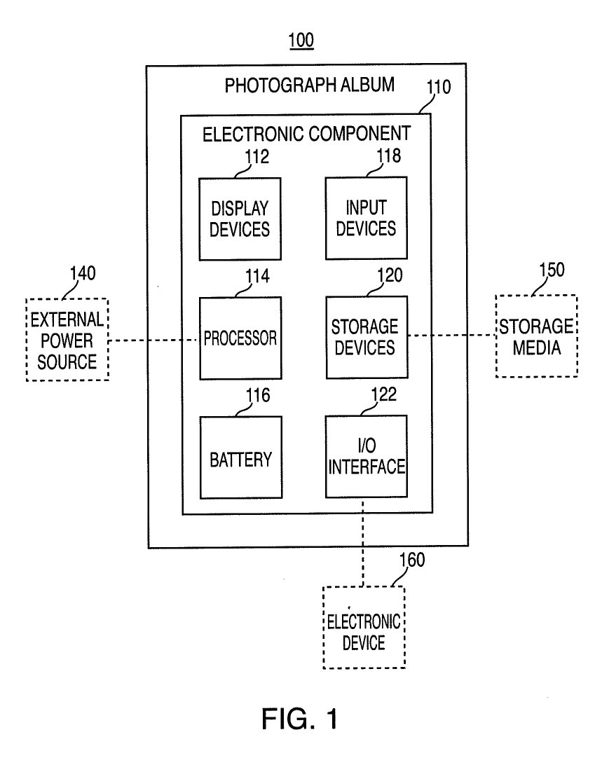

FIG. 1 shows a simplified schematic of album 100 in accordance with an embodiment of the present invention. Album 100 may include electronic component 110. For example, album 100 may include a compartment and electronic component 110 may be disposed in that compartment. Electronic component 110 may be interchangeable among one or more albums (e.g., one or more instances of album 100).

Electronic component 110 may include display device 112 and processor 114. Display device 112 may be operable to display digital photographs. In an embodiment, display device 112 may be operable to display digital video. Display device 112 may, for example, be an LCD display. Display device 112 may be of any suitable size for viewing digital photographs (e.g., 1.5″ diagonal, 3.5″ diagonal or 8″ diagonal). Display device 112 may be electrically coupled to processor 114. Processor 114 may be any suitable processor for controlling display device 112 (e.g., a microprocessor).

Electronic component 110 may also include battery 116 that is electrically coupled to circuitry within electronic component 110. Battery 116 may provide electric power to electronic component 110 and its various subsystems (e.g., display device 112, processor 114). Battery 116 may include one or more electrochemical batteries. Battery 116 may, for example, be a rechargeable battery. Electronic component 110 may include a physical interface (e.g., a connector) for electrically coupling with external power source 140 (e.g., an AC wall outlet) to charge battery 116. An AC to DC converter may be provided externally to electronic component 110 or may be provided through circuitry in electronic component 110. Electronic component 110 may include circuitry (e.g., in processor 114) for monitoring and controlling the charging of battery 116. Electronic component 110 may also include circuitry (e.g., in processor 114) for controlling the distribution of electric power from battery 116. In an embodiment, battery 116 may be one or more replaceable batteries (e.g., four AA batteries).

Electronic component 110 may include input device 118 that is electrically coupled to processor 114. A user may be able to interact with input device 118 to provide user inputs (e.g., turn on, next photograph, previous photograph or play slideshow). Input device 118 may include one or more mechanical structures (e.g., buttons or levers) for receiving user inputs. Input device 118 may be combined with display device 112 in the form of a touch-screen panel that can both display digital photographs and receive user inputs. In an embodiment, input device 118 may include a voice recognition system for receiving user inputs.

Electronic component 110 may include storage device 120 that is electrically coupled to processor 114. Storage device 120 may be operable to store one or more digital photographs. Storage device 120 may be any suitable data storage device. For example, storage device 120 may be a magnetic hard disk drive or flash memory. Storage device 120 may be electrically coupled to display device 112 such that digital photographs stored on storage device 120 may be displayed on display device 112. Storage device 120 may store software for use by processor 114.

In an embodiment, storage device 120 may be operable to interface with portable storage media 150. Storage device 120 may include a physical interface (e.g., a connector) for electrically coupling with portable storage media 150. Storage media 150 may be portable storage media suitable for storing one or more digital photographs. For example, portable storage media 150 may be a memory card (e.g., SD flash memory cards or portable USB memory). Portable storage media 150 may also store software for use by processor 114. For example, portable storage media 150 may store a new version of software for use by processor 114. Storage device 120 may interface with portable storage media 150 in addition to any internal storage media (e.g., a hard disk drive or internal flash memory). For example, electronic component 110 may be operable to download one or more digital photographs from storage media 150 to internal storage in storage device 120. In this example, the one or more downloaded photographs may be stored on storage device 120 indefinitely and available for display on display device 112. In another example, electronic component 110 may be operable to upload one or more digital photographs from internal storage in storage device 120 to storage media 150. In this manner, a user can share copies of digital photographs stored in electronic component 110 by uploading them to storage media 150. Both uploading and downloading of digital photographs to and from, respectively, storage media 150 may be initiated by a user (e.g., through input device 118). In an embodiment, transferring photographs to or from storage media 150 may be initiated automatically when the media is connected to component 110.

In an embodiment, storage device 120 may not include internal storage media and may use portable storage media 150 instead. In an embodiment, storage device 120 may include a cavity for receiving portable storage media 150 (e.g., an SD memory card slot) so that the portable media is protected inside electronic component 110. In an embodiment, photograph album 100 may include one or more cavities or pockets such that each cavity can hold an instance of storage media 150. For example, each instance of storage media 150 may include a different set of digital photographs such that a user can display different sets of photographs by changing which storage media 150 is connected to electronic component 110.

Electronic component 110 may include I/O interface device 122 that is electrically coupled to processor 114. I/O interface device 122 may be operable to interface with electronic device 160 (e.g., a computer, a digital camera or a printer). I/O interface device 122 may include a physical interface (e.g., a connector) for electrically coupling electronic component 110 with electronic device 160. I/O interface device 122 may be able to communicate with electronic device 160 using one or more suitable protocols. For example, I/O interface device 122 may be able to communicate with electronic device 160 using a Universal Serial Bus (USB) or Firewire protocol. Depending on the protocols, I/O interface device 122 may include circuitry for processing signals going to or coming from electronic device 160. In an embodiment, I/O interface device 122 may be operable to interface with electronic device 160 wirelessly (e.g., using an IEEE 802.11 standard).

I/O interface device 122 may be operable to receive digital photographs from electronic device 160. Similar to storage device 120 communicating with storage media 150, I/O interface device 122 may allow electronic component 110 to download digital photographs from electronic device 160 and store them in storage device 120. I/O interface device 122 may be operable to transmit digital photographs to electronic device 160. For example, I/O interface device 122 may allow a user to share copies of digital photographs stored on component 110 by uploading them to another electronic device. Similar to initiating transfers with storage media 150, uploading and downloading of digital photographs to and from, respectively, electronic device 160 may be initiated by a user (e.g., through input device 118 or electronic device 160) or automatically upon connection to electronic device 160.

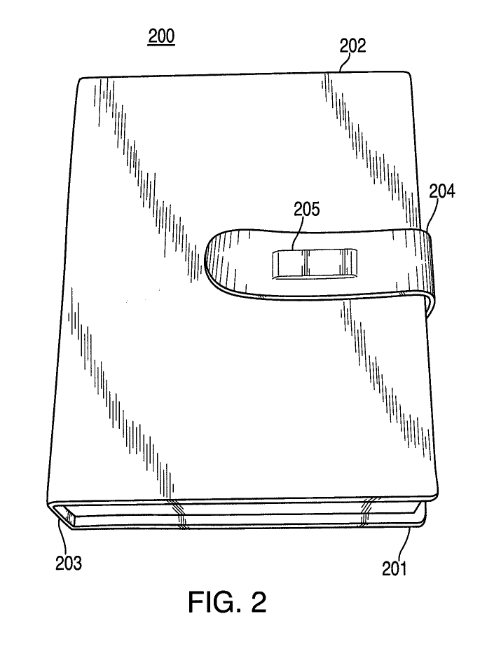

FIG. 2 shows a front perspective view of album 200 in accordance with an embodiment of the present invention. Album 200 may have a shape resembling a book. Album 200 may include rear cover 201 and front cover 202 coupled to the rear cover. Album 200 may have spine 203 coupling the front cover to the rear cover. Front cover 202 may be moveable with respect to rear cover 201 between a closed and open position. As seen in FIG. 2, front cover 202 is in a closed position.

Album 200 may include a mechanism for securing front cover 202 in a closed position (e.g., preventing front cover 202 from accidentally opening). For example, album 200 may include strap 204 which can be coupled with front cover 202. Strap 204 may include magnet 205 that is magnetically attracted to a corresponding ferromagnetic material in front cover 202 to prevent front cover 202 from accidentally opening. It is understood that other suitable mechanisms can be used to prevent front cover 202 from accidentally opening. For example, strap 204 may be provided with a mechanical fastener for attaching strap 204 to front cover 202. In another example, front cover 202 may include a fastener for coupling with an interior portion of album 200 and thereby eliminating a need for strap 204.

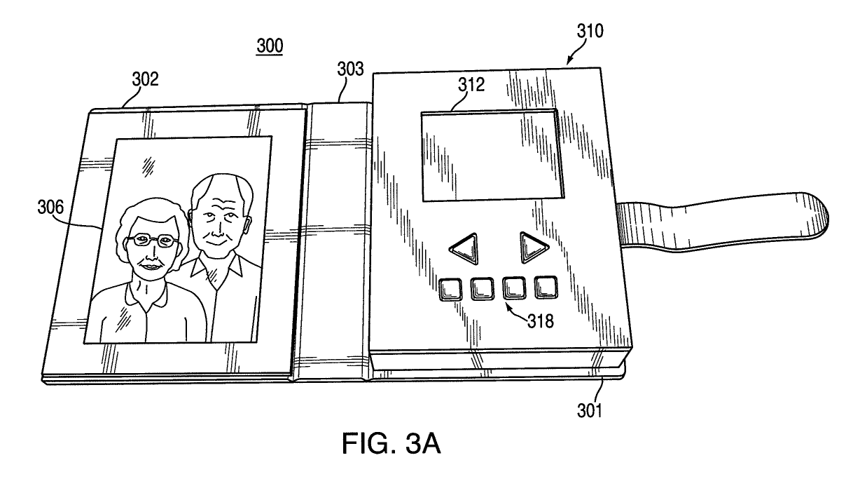

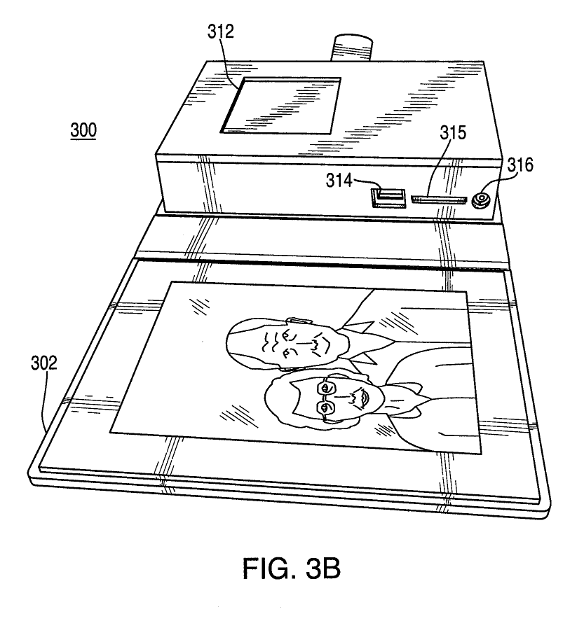

FIGS. 3A and 3B show perspective views of album 300 in accordance with an embodiment of the present invention. With respect to the perspective view in FIG. 3A, album 300 may include rear cover 301, front cover 302 and spine 303. Front cover 302 may be in an open position and may include pocket 306 for displaying a physical photograph. Pocket 306 may have a transparent viewing window on the interior surface of the album. It is understood that any surface (e.g., interior or exterior) of either album cover (e.g., front or back) may include a pocket similar to pocket 306.

Album 300 may include compartment 310 attached to the interior surface of rear cover 301. An electronic component (e.g., component 110 of FIG. 1) may be disposed within compartment 310. Viewing aperture 312 may be provided in compartment 310. Viewing aperture 312 may allow a user to see the display device (e.g., display device 112 of FIG. 1) of an electronic component stored in compartment 310. Compartment 310 may include apertures 318 which may allow a user to access the input device (e.g., input device 118 of FIG. 1) of an electronic component stored therein. Apertures 312 and 318 may be provided in compartment 310 such that the apertures are covered when front cover 302 is in a closed position. Accordingly, front cover 302 may protect the display device and input device of an electronic component stored in compartment 310 when the front cover is closed. In an embodiment, front cover 302 may be hinged such that it can fold over compartment 310 and protect an electronic component therein. This hinged configuration may be advantageous because it can provide protection for the fragile parts of an electronic component during times when album 300 is not being used (e.g., during transportation of the album in a bag or purse).

With respect to the perspective view in FIG. 3B, compartment 310 may also include apertures 314, 315 and 316 to allow an electronic component (see, e.g., component 110 of FIG. 1) stored in album 300 to interface with, respectively, other electronic devices, portable storage media and an external power source. In alternative to several smaller apertures, compartment 310 may include one large aperture that allows access to multiple connectors.

In an embodiment, the apertures provided in compartment 310 may interface with an electronic component to determine when front cover 302 is opened. The electronic component may automatically turn itself on based on the determination. For example, an ambient light sensor may be provided as an input device (see, e.g., input device 118 of FIG. 1) to the electronic component such that, when cover 302 is opened, ambient light reaches the sensor and triggers the electronic component to turn on. In another example, a push button switch (not pictured) may be biased to extend through one of the apertures 314, 315, and 316 such that, as cover 302 and spine 303 move away from compartment 310, the switch extends and triggers the electronic component's turn on sequence.

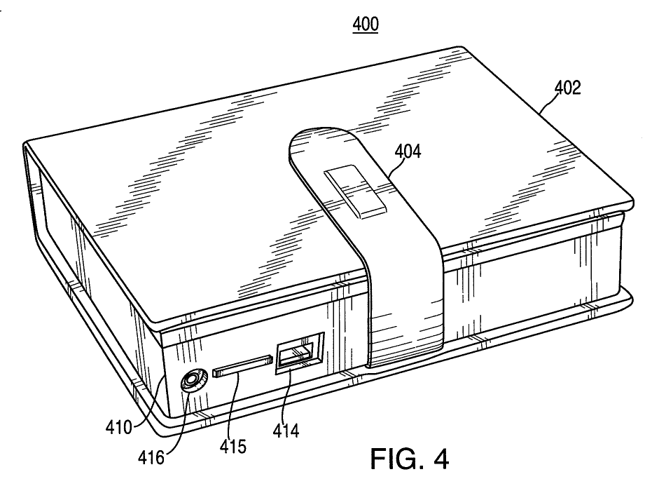

FIG. 4 shows a side perspective view of album 400 having compartment 410 in accordance with an embodiment of the present invention. Album 400 may be similar to album 200 and album 300. However, compartment 410 may, unlike compartment 310 (FIG. 3) include apertures 414, 415 and 416 to allow an electronic component (see, e.g., component 110 of FIG. 1) stored therein to interface with, respectively, other electronic devices, portable storage media and an external power source while front cover 402 of album 400 is in a closed position. Apertures 414, 415 and 416 may even be accessible when strap 404 is securely coupled to front cover 402.

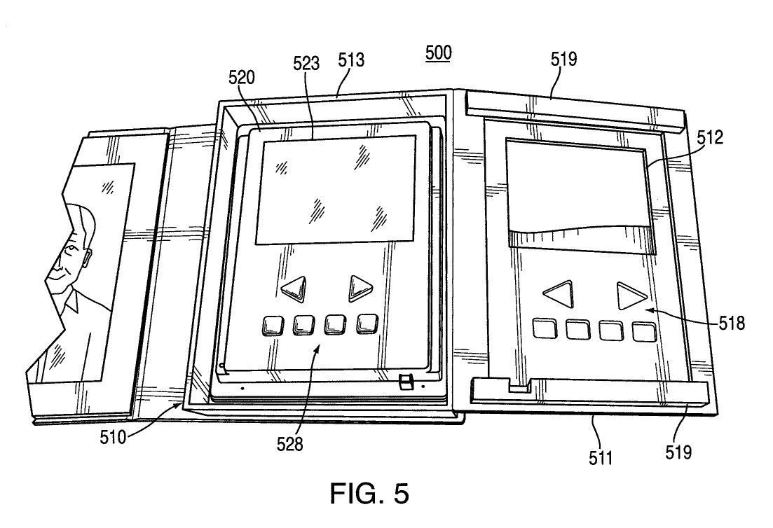

FIG. 5 shows a front perspective view of electronic component 520 provided in album 500 in accordance with an embodiment of the present invention. Album 500 may include compartment 510, compartment flap 511 and compartment base 513. Flap 511 may be coupled to compartment base 513 such that flap 511 is movable between an open and closed position. As seen in FIG. 5, flap 511 is in an open position.

Electronic component 520 (see, e.g., component 110 of FIG. 1) is located in compartment base 513 such that it is exposed when compartment flap 511 is in an open position. Electronic component 520 includes display device 523 (see, e.g., display device 112 of FIG. 1) that corresponds to aperture 512 (see, e.g., aperture 312 of FIG. 3A) in compartment flap 511. When compartment flap 511 is closed, aperture 512 aligns with display device 523 such that a user can see display device 523. Similarly, electronic component 520 includes input device 528 (see, e.g., input device 118 of FIG. 1) that corresponds to apertures 518 (see, e.g., apertures 318 of FIG. 3A) in compartment flap 511. Accordingly, when compartment flap 511 is closed, apertures 518 align with input device 528 such that a user can interact with input device 528.

Input device 528 may include any number of input mechanisms (e.g., buttons). The complexity (e.g., number of buttons) of input device 528 may depend, for example, on the functionality and complexity of component 520. For example, input device 528 may include only one button for turning component 520 on and off and one button for changing the digital photograph displayed on display device 523. In an embodiment, a broad range of functions can be provided by input device 528. For example, different buttons can be associated with different sets of photographs such that a user can easily navigate between the sets. In an embodiment, one button may be associated with a print command such that, if a printer is connected to electronic component 520, the picture currently displayed on display device 523 is sent to the printer in response to the button being pressed. In an embodiment, a button can be associated with transferring files such that, when the button is pressed, one or more photographs may are transferred to a portable storage media or other electronic device electrically coupled to electronic component 520.

Compartment base 513 may be sized to fit electronic component 520. In an embodiment, compartment base 513 may include a compressible (e.g., made from foam) lining for protecting electronic component 520 from shock. Compartment flap 511 may also include compressible (e.g., made from foam) portions 519 to protect electronic component 520 when flap 511 is in a closed position.

A latching mechanism may be provided to prevent compartment flap 511 from accidentally opening. For example, a magnet and corresponding ferromagnetic material may be provided in compartment base 513 and compartment flap 511 such that flap 511 is magnetically attracted to base 513. In an embodiment, compartment flap 511 may be sized and shaped to snugly interfit with base 513 such that flap 511 will not accidentally open. When compartment flap 511 is open, a user may be able to easily remove electronic component 520. For example, a user may be able to simply lift electronic component 520 out of compartment base 513 without using any tools. In such a manner, electronic component 520 may be interchangeable among several different instances of album 500. In an embodiment, each instance of album 500 may have a different style, design or color such that an appropriate or desirable album may be selected for use with electronic component 520.

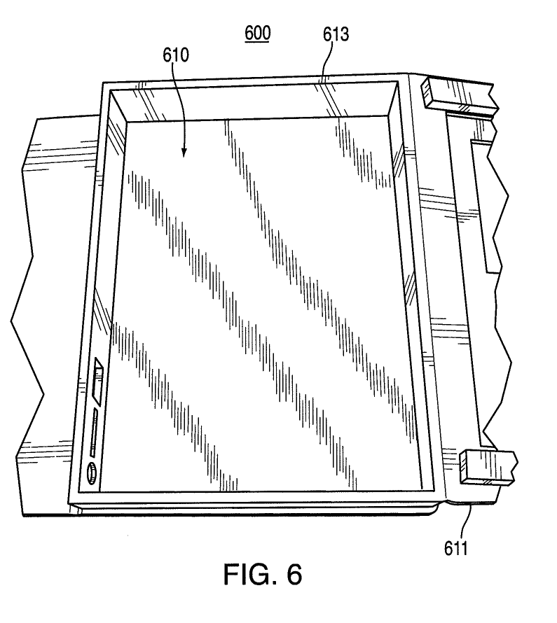

FIG. 6 shows a front perspective view of album 600 in accordance with an embodiment of the present invention. Album 600 includes compartment 610 having compartment flap 611 and compartment base 613. As seen in FIG. 6, there is no electronic component in compartment 610. However, an electronic component can be easily placed in compartment 610 and compartment flap 611 closed to install an electronic component in album 600. The aforementioned installation process is simple for a user to complete and can be done without the use of any tools.

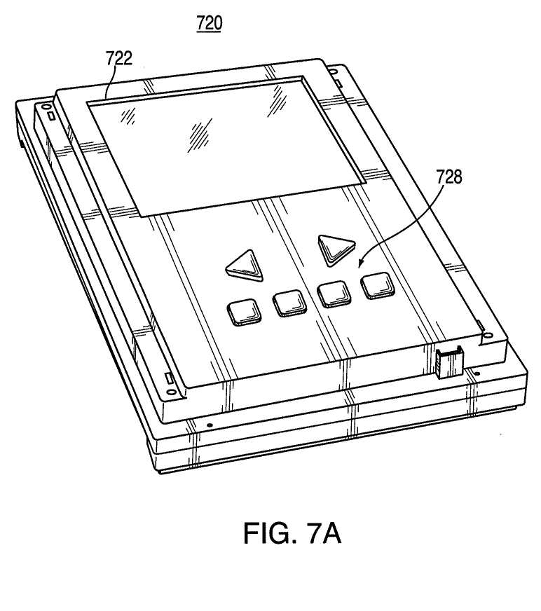

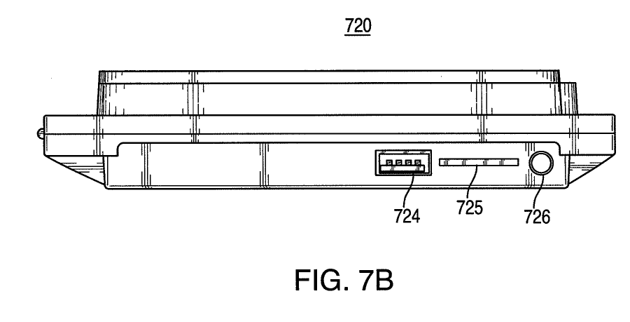

FIGS. 7A and 7B show front and side perspective views, respectively, of electronic component 720 in accordance with an embodiment of the present invention. Component 720 (see, e.g., component 110 of FIG. 1) is a component for use with a photograph album. For example, component 720 can be considered a representation of component 520 if it were removed from album 500. Component 720 is interchangeable meaning that it is not necessarily associated with any particular album but can be installed in any album that has an adequate compartment (see, e.g., compartment 610 of FIG. 6) for receiving it. With respect to the perspective views in both FIGS. 7A and 7B, component 720 can include display device 722 (see, e.g., display device 112 of FIG. 1), input device 728 (see, e.g., input device 118 of FIG. 1), I/O connector 724 (see, e.g., I/O interface device 122 of FIG. 1), portable storage media connector 725 (see, e.g., storage device 120 and storage media 150 of FIG. 1), and external power connector 726 (see, e.g., battery 116 of FIG. 1). Electronic component 720 may be operable to display digital photographs without being installed in an album. However, component 720 is preferably used within an album because of the numerous protective advantages of the albums described herein.

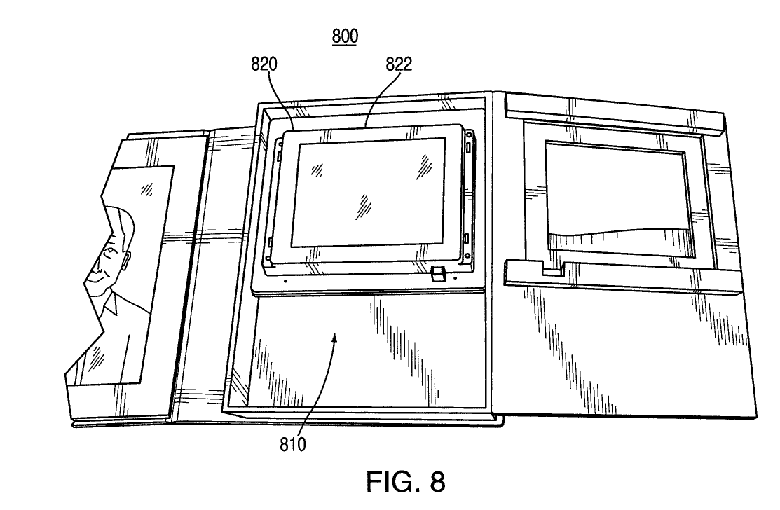

FIG. 8 shows a front perspective view of electronic component 820 provided in album 800 in accordance with an embodiment of the present invention. Album 800 includes electronic component 820 (see, e.g., electronic component 110 of FIG. 1) for displaying digital photographs. Electronic component 820 may include display device 822 which may be a touch-screen system. Accordingly, display device 822 may also function as an input device (see, e.g., input device 118 of FIG. 1) because it can receive user inputs through touch. As a result of this consolidation, component 820 may be smaller and lighter. Additionally, free space may be created in compartment 810. This free space may, for example, be used to provide additional compressible material to protect component 820 from shock. In an embodiment, this free space may be used to hold portable storage media or physical photographs.

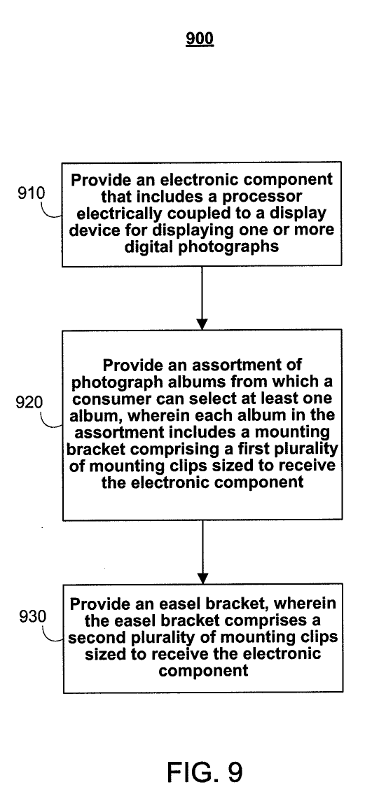

FIG. 9 shows flowchart 900 of a method for providing a portable photograph album in accordance with an embodiment of the present invention. At step 910, an electronic component may be provided that includes a processor electrically coupled to a display device for displaying one or more digital photographs. The electronic component provided at step 910 may include an input/output interface, electrically coupled to the processor, for interfacing with other electronic components or storage media. In an embodiment, the electronic component provided at step 910 may include a storage device, electrically coupled to the processor, for storing one or more digital photographs. In an embodiment, the electronic component provided at step 910 may include an input device, electrically coupled to the processor, for receiving user inputs. In an embodiment, the electronic component provided at step 910 may include a battery, electrically coupled to the processor, for powering the electronic component. For example, a component similar to component 720 in FIG. 7 may be provided to a consumer.

At step 920, an assortment of photograph albums from which a consumer can select at least one album may be provided. Each album in the assortment may include a mounting bracket comprising a first plurality of mounting clips sized to receive the electronic component. For example, an assortment of albums comparable to album 200 in FIG. 2 may be provided to a consumer. Each album in the assortment may include a rear cover and a front cover coupled to the rear cover, wherein the front cover is moveable between an open position and a closed position. The display device of the electronic component may not be visible when the electronic component is disposed in the album and the front cover is in the closed position. In an embodiment, each album in the assortment may include a pocket for holding a printed photograph. The pocket may be disposed between the front cover and the rear cover.

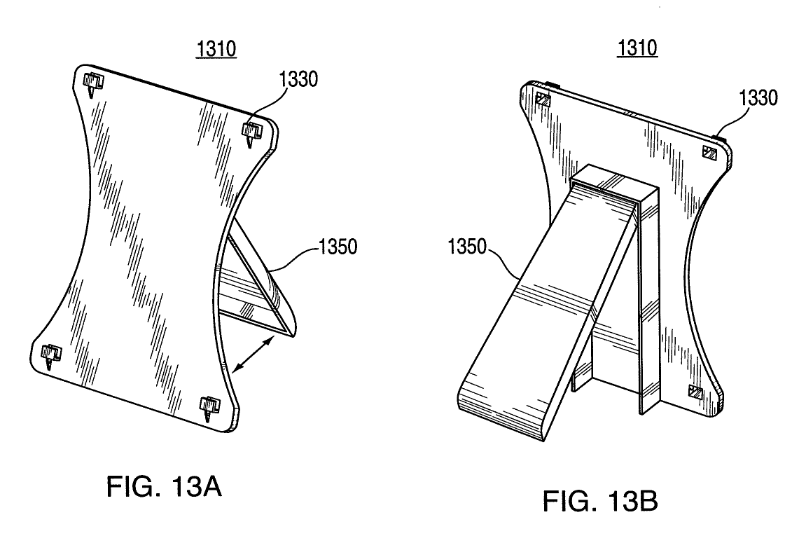

At step 930, an easel bracket comprising a second plurality of mounting clips sized to receive the electronic component may be provided. For example, an easel bracket comparable to easel bracket 1310 (see FIG. 13) may be provided to a consumer. Each easel bracket may include a set of mounting clips that are sized to receive the electronic component. The user may remove the electronic component from the album and place the electronic component on the easel bracket without the use of tools.

In an embodiment, the assortment of albums may include albums having different colors or styles. In an embodiment, the assortment of albums may include albums having different themes (e.g., birthday, graduation or vacation).

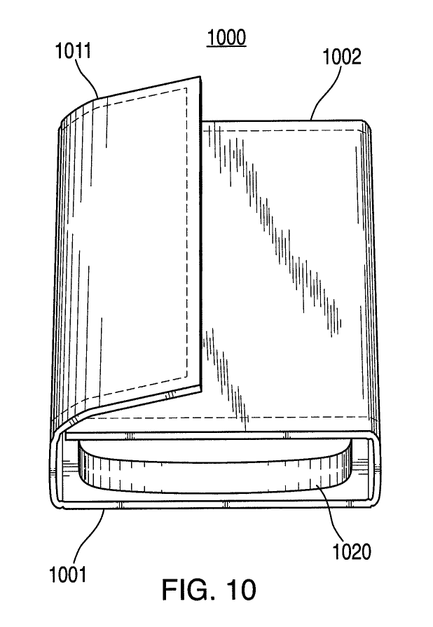

FIG. 10 shows a front perspective view of album 1000 in accordance with an embodiment of the present invention. Album 1000 may have a shape resembling a book. Album 1000 may include rear cover 1001 and front cover 1002 coupled to the rear cover. Front cover 1002 may be moveable with respect to rear cover 1001 between a closed and open position. As seen in FIG. 10, front cover 1002 is in a closed position.

Album 1000 may include a mechanism for securing front cover 1002 in a closed position (e.g., preventing front cover 1002 from accidentally opening). For example, album 1000 may include flap 1011 which can be coupled with rear cover 1001. Flap 1011 may include a magnet that is magnetically attracted to a corresponding ferromagnetic material in front cover 1002 to prevent front cover 1002 from accidentally opening. It is understood that other suitable mechanisms can be used to prevent front cover 1002 from accidentally opening. For example, flap 1011 may be provided with a mechanical fastener for attaching flap 1011 to front cover 1002. In another example, front cover 1002 may include a fastener for coupling with an interior portion of album 1000 thereby eliminating a need for flap 1011.

Album 1000 includes electronic component 1020 (similar to, e.g., electronic component 110 of FIG. 1) for displaying digital photographs. Electronic component 1020 may be disposed between front cover 1002 and rear cover 1001. Flap 1011 may securely fasten electronic component 1020 in album 1000.

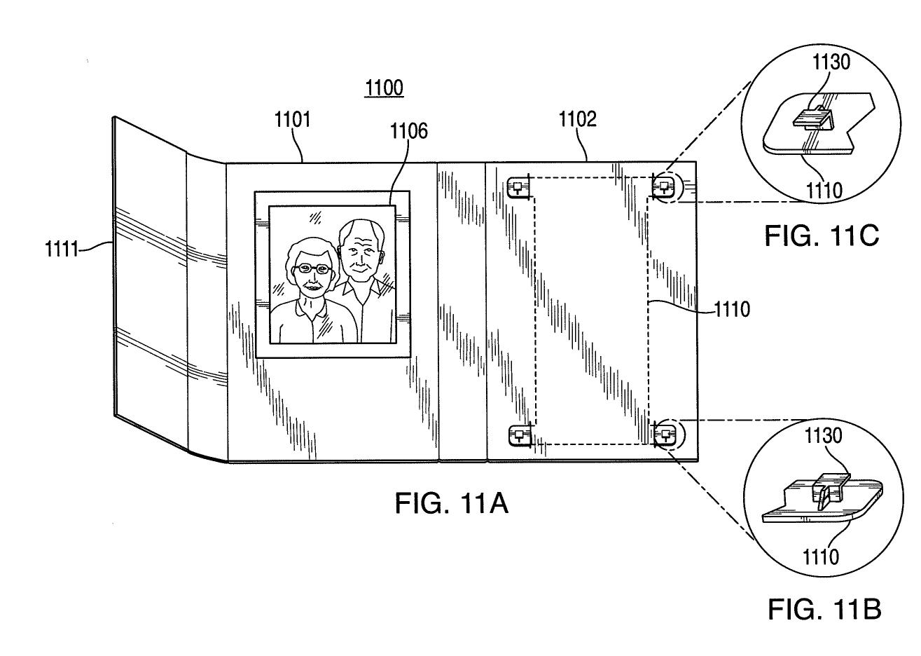

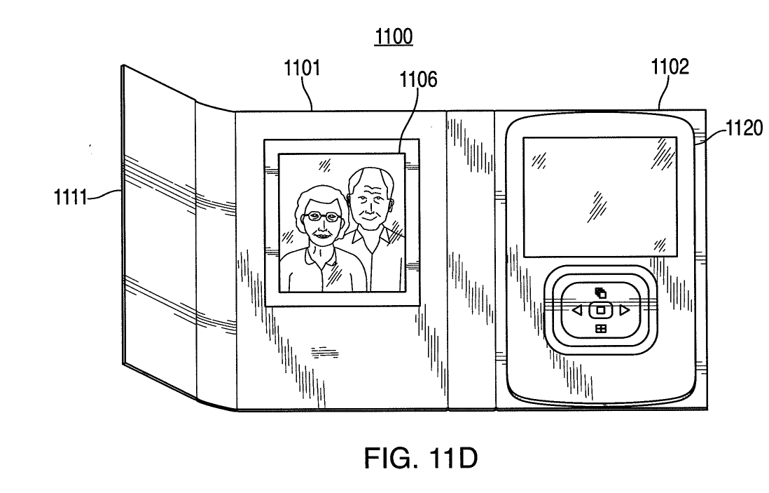

FIG. 11 shows a front perspective view of album 1100 in accordance with an embodiment of the present invention. Album 1100 may include rear cover 1101, front cover 1102 and flap 1111. Flap 1111 may be coupled to rear cover 1101 such that flap 1111 is moveable between an open and closed position. As shown in FIG. 11, flap 1111 is in an open position. Rear cover 1101 may be exposed when front cover 1102 and flap 1111 are in an open position. Rear cover 1101 may include pocket 1106 for displaying a physical photograph. Pocket 1106 may have a transparent viewing window on the interior surface of the album, and may be substantially similar to pocket 306 of FIG. 3A.

Album 1100 may include mounting bracket 1110 disposed in the interior surface of front cover 1102. Mounting bracket 1110 may include mounting clips 1130 which may allow a user to engage an electronic component (see, e.g., FIG. 11D) to the mounting bracket. Front cover 1102 may protect the display device and input device of an electronic component stored on mounting bracket 1110 when front cover 1102 is in a closed position.

Mounting bracket 1110 may include mounting clips 1130 for interfacing with an electronic component. Mounting clips 1130 may be shaped specifically to engage an electronic component. For example, a user may fasten an electronic device to the mounting clips 1130 to securely place the electronic device within album 1100. In an embodiment, mounting clips 1130 may have a different geometry from that shown in FIGS. 11C and 11D. For example, mounting clips 1130 may be have a “T-shaped” geometry for engaging an electronic component by sliding into position. In another embodiment, mounting bracket 1110 may engage an electronic component without the use of mounting clips 1130. For example, mounting bracket 1100 may be provided with a strap to secure an electronic component. The strap may be comprised of an elastic material held sufficiently taut so that an electronic component disposed therein is rigidly supported and fixed with zero degrees of freedom.

FIG. 11D shows a front perspective view of electronic component 1120 (see, e.g., component 110 of FIG. 1) provided in album 1100 in accordance with an embodiment of the present invention. Electronic component 1120 may be located on mounting bracket 1110 such that it is exposed when front cover 1102 and flap 1111 are in an open position. When electronic component 1120 is engaged with mounting bracket 1110 via mounting clips 1130, electronic component 1120 is rigidly supported and fixed with zero degrees of freedom. For example, if album 1100 were to be held open with the anterior surface of electronic component 1120 oriented downward, electronic component 1120 would not become detached from album 1100. Further, if album 1100 were to be held open at any other orientation, electronic component 1120 would not fall.

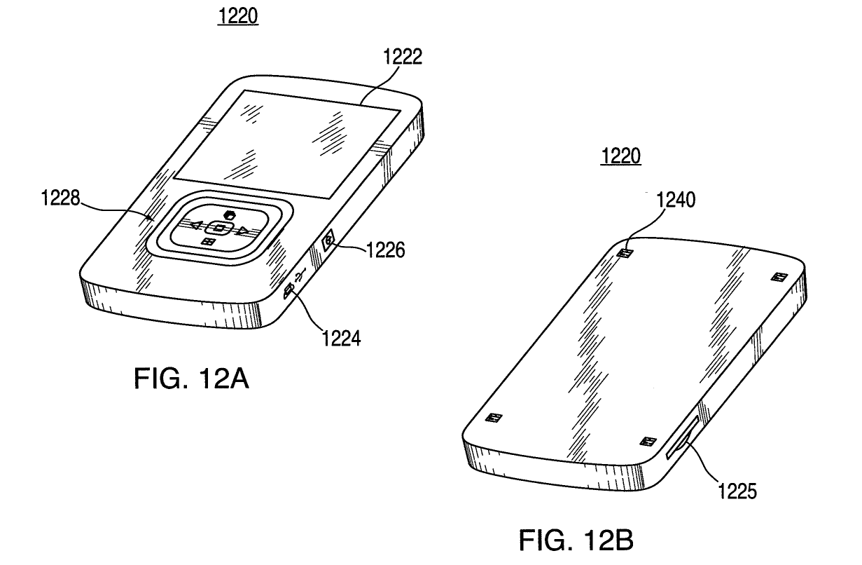

FIGS. 12A and 12B show front and rear perspective views, respectively, of electronic component 1220 for use in an album, such as album 1100 in FIG. 11, in accordance with an embodiment of the present invention. With regard to display device 1222, input device 1228, and portable storage media connector 1225, electronic component 1220 may be substantially similar to electronic component 720. However, electronic component 1220 may, unlike electronic component 720, include a combination I/O connector (see, e.g., I/O connector 724 of FIG. 7B) and external power connector (see, e.g., external power connector 726 of FIG. 7B) shown as I/O power connector 1224. Electronic component 1220 may also include power on/off button 1226 for allowing a user to turn electronic component 1220 on or off.

Electronic component 1220 may contain mounting clip attachments 1240 on the posterior surface for interfacing with the mounting clips of an album or easel bracket (such as easel bracket 1310 in FIG. 13). Attachments 1240 may be shaped to receive a particular geometry of mounting clip. In an embodiment, attachments 1240 may be shaped such that they may receive numerous geometries of mounting clips. For example, attachments 1240 may receive a first geometry of mounting clips for one bracket and may be interchangeable with another bracket with a second geometry of mounting clips.

FIGS. 13A and 13B show front and rear perspective views, respectively, of easel bracket 1310 in accordance with an embodiment of the present invention. Easel bracket 1310 may include mounting clips 1330 for engaging an electronic component. Mounting clips 1330 may be geometrically the same shape as mounting clips 1130 in FIG. 11 such that an electronic component disposed in an album may be removed and interchangeably engaged to easel bracket 1310 without the use of tools.

Easel bracket 1310 may include stand 1350 for setting easel bracket 1310 in an upright position. Stand 1350 may be operable to fold against easel bracket 1310 for the purposes of storing easel bracket 1310 in a space efficient manner. In an embodiment, easel bracket 1310 may engage an electronic component without the use of mounting clips 1330. For example, a bottom lip may be provided to hold an electronic component when easel bracket 1310 is in an upright position when stand 1350 is engaged.

In an embodiment, an album (see, e.g., album 1000) may have no front cover and no flap. In such an embodiment, electronic component 1020 may be engaged with a mounting bracket disposed in rear cover 1001. In another embodiment, album 1000 may have no rear cover and no flap. In such an embodiment, electronic component 1020 may be engaged with a mounting bracket disposed in front cover 1002. In the foregoing embodiments, album 1000, including only a rear cover 1001 or only a front cover 1002, may form an enclosure for album 1000. In another embodiment, album 1000 may have front cover 1002 and flap 1011, wherein flap 1011 is coupled to front cover 1002, and no rear cover. In another embodiment, album 1000 may have rear cover 1001 and flap 1011 and no front cover. The foregoing album cover arrangements are neither comprehensive nor limiting to the present invention. It is to be understood that other suitable arrangements may be used to comprise an album cover. For example, the length and width of any of rear cover 1001, front cover 1002, and flap 1011 may be adjusted to cover more, or less, of electronic component 1120 stored therein.

It is to be understood that the principles of the present invention are not limited to the sizes or configurations described in the discussions above and can be applied to any type of photograph album.

It is to be understood that the foregoing is only illustrative of the principles of the invention, and that various modifications can be made by those skilled in the art without departing from the scope and spirit of the invention, and the present invention is limited only by the claims that follow.

What is claimed is:

1. A digital photograph album device comprising:
a rear cover;
a front cover coupled to the rear cover;
a compartment disposed between the front cover and the rear cover and having an aperture; and
an electronic component disposed within the compartment, the electronic component including a display device visible through the aperture and a processor, wherein the display device is electrically coupled to the processor and the display device displays one or more digital photographs.

2. The device of claim 1, wherein the electronic component is removably disposed within the compartment.

3. The device of claim 1, wherein the front cover is movable between an open position and a closed position.

4. The device of claim 3, wherein the display device is protected when the front cover is in the closed position.

5. The device of claim 1, further comprising:
a pocket for holding a printed photograph, the pocket being disposed between the front cover and the rear cover.

6. The device of claim 5, wherein the pocket is provided on an interior surface of the front cover.

7. The device of claim 1, wherein the electronic component is interchangeable.

8. The device of claim 7, wherein the compartment has a moveable flap for removing the electronic component.

9. The device of claim 1, wherein the electronic component includes a storage device, electrically coupled to the processor, for storing at least one of the one or more digital photographs.

10. The device of claim 1, wherein the electronic component includes an input/output interface, electrically coupled to the processor, for interfacing with other electronic components or electronic storage media.

11. The device of claim 10, wherein:
the input/output interface includes one or more connectors for physically interfacing with other electronic components or storage media; and
the compartment includes one or more connector apertures allowing access to the one or more connectors.

12. The device of claim 1, wherein the electronic component includes an input device, electrically coupled to the processor, for receiving user inputs.

13. The device of claim 1, wherein the electronic component includes a battery, electrically coupled to the processor, for powering the electronic component.

14. A digital photograph album device comprising:
a rear cover;
a front cover coupled to the rear cover;
an interchangeable electronic component disposed between the front cover and the rear cover having a processor and a display device, wherein:
the processor is electrically coupled to the display device;
the display device displays one or more digital photographs; and
the interchangeable electronic component is removable from the device without tools.

15. A method for providing a portable photograph album, the method comprising:
providing an electronic component that includes a processor electrically coupled to a display device for displaying one or more digital photographs;
providing an assortment of photograph albums from which a consumer can select at least one album, wherein each album in the assortment includes a mounting bracket comprising a first plurality of mounting clips sized to receive the electronic component; and
providing an easel bracket, wherein the easel bracket comprises a second plurality of mounting clips sized to receive the electronic component.

16. The method of claim 15, wherein the providing an electronic component further comprises:
providing an input/output interface electronically coupled to the processor for interfacing with other electronic components or storage media.

17. The method of claim 15, wherein the providing an electronic component further comprises:
providing a storage device electronically coupled to the processor for storing one or more digital photographs.

18. The method of claim 15, wherein the providing an electronic component further comprises:
providing an input device electronically coupled to the processor for receiving user inputs.

19. The method of claim 15, wherein the providing an electronic component further comprises:
providing a battery electronically coupled to the processor for powering the electronic component.

20. The method of claim 15, wherein the providing an electronic component further comprises:
providing a plurality of mounting clip attachments on the posterior surface of the electronic component;
removing the electronic component from the album; and
engaging the plurality of mounting clip attachments to one of the first plurality of mounting clips and the second plurality of mounting clips.

21. The method of claim 20, wherein removing the electronic component from the album and engaging the plurality of mounting clip attachments to one of the first plurality of mounting clips and the second plurality of mounting clips is done without the use of tools.

22. The method of claim 15, wherein the first plurality of mounting clips and the second plurality of mounting clips are geometrically the same.

23. The method of claim 15, wherein the electronic component is rigidly supported by the mounting bracket when disposed within the digital photograph album.

24. The method of claim 15, wherein the electronic component is restricted to zero degrees of freedom when disposed within the digital photograph album.

25. A digital photograph album device comprising:
a rear cover;
a front cover coupled to the rear cover;
a mounting bracket disposed between the front cover and the rear cover; and
an electronic component disposed anterior to the mounting bracket, the electronic component including a display device and a processor, wherein the display device is electrically coupled to the processor and the display device displays one or more digital photographs.

26. The device of claim 25, wherein the electronic component is rigidly supported by the mounting bracket when disposed within the digital photograph album.

27. The device of claim 25, wherein the electronic component is restricted to zero degrees of freedom when disposed within the digital photograph album.

28. The device of claim 25, further comprising:
a first plurality of mounting clips disposed within the mounting bracket and sized to receive the electronic component; and
an easel bracket, wherein the easel bracket comprises:
a second plurality of mounting clips sized to receive the electronic component; and
a stand.

29. The device of claim 28, further comprising a plurality of mounting clip attachments disposed on the posterior surface of the electronic component and sized to receive one of the first plurality of mounting clips and the second plurality of mounting clips.

30. The device of claim 29, wherein the plurality of mounting clip attachments are sized to receive one of the first plurality of mounting clips and the second plurality of mounting clips without the use of tools.

31. The device of claim 28, wherein the first plurality of mounting clips and the second plurality of mounting clips are geometrically the same.

32. The device of claim 25, wherein the mounting bracket is disposed within a pocket within the front cover and wherein the mounting bracket is rigidly supported by the pocket.

33. The device of claim 25, wherein the electronic component further comprises an ambient light sensor.

34. The device of claim 33, wherein the electronic component is automatically turned on when the ambient light sensor determines that the front cover is open, and wherein the electronic component is automatically turned off when the ambient light sensor determines that the front cover is closed.

35. A digital photograph album device comprising:
an enclosure;
a mounting bracket disposed in the enclosure; and
an electronic component disposed anterior to the mounting bracket, the electronic component including a display device and a processor, wherein the display device is electrically coupled to the processor and the display device displays one or more digital photographs.

36. The device of claim 35, wherein the electronic component is rigidly supported by the mounting bracket when disposed within the enclosure.

37. The device of claim 35, further comprising:
a first plurality of mounting clips disposed within the mounting bracket and sized to receive the electronic component; and
an easel bracket, wherein the easel bracket comprises:
a second plurality of mounting clips sized to receive the electronic component; and
a stand.

38. The device of claim 35, further comprising a pocket within the enclosure, and wherein the mounting bracket is rigidly supported by the pocket.
